(19) United States
(12) Patent Application Publication
(10) Pub. No.: US 2018/0040407 A1
(43) Pub. Date: Feb. 8, 2018

(54) REACTOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Shinichiro Yamamoto, Yokkaichi, Mie (JP); Kouhei Yoshikawa, Yokkaichi, Mie (JP)

(21) Appl. No.: 15/547,720

(22) PCT Filed: Jan. 29, 2016
(86) PCT No.: PCT/JP2016/052755

§ 371 Date: Jul. 31, 2017

(30) Foreign Application Priority Data
Feb. 18, 2015 (JP) 2015-030109

(51) Int. Cl. H01F 27/02; H01F 41/00; H01F 41/02; H01F 27/24; H01F 27/26

(52) U.S. Cl. CPC H01F 27/022; H01F 27/24; H01F 27/263; H01F 41/0206; H01F 41/005

(57) ABSTRACT

Provided is a reactor configured to hold constituent components of the reactor at predetermined positions relative to each other during the manufacturing process thereof so as to increase productivity. The reactor includes: a coil having winding portions; magnetic cores formed by combining a plurality of core pieces and gap members interposed between the core pieces, and includes portions that are located inside the winding portions; interposed members interposed between inner surfaces of the winding portions and the magnetic cores, and include a core holding portion that secures gaps between the plurality of core pieces, and position the core pieces; a casing that houses a combined body that includes the coil, the magnetic cores, and the interposed members; and a sealing resin portion that fills the casing and seals the combined body. The gap members are formed using a constituent resin of the sealing resin portion.

### CROSS-REFERENCE TO RELATED APPLICATIONS

This application is the U.S. national stage of PCT/JP2016/052755 filed Jan. 29, 2016, which claims priority of Japanese Patent Application No. JP 2015-030109 filed Feb. 18, 2015.

### TECHNICAL FIELD

The present invention relates to a reactor that is used as a constituent component of an on-board DC-DC converter and a power conversion device that are mounted on a vehicle such as a hybrid vehicle.

### BACKGROUND

Magnetic components such as reactors and motors are used in various fields. For example, JP 2012-253384A discloses, as an example of such a magnetic component, a reactor that is used as a circuit component of an on-board converter. JP 2012-253384A discloses a reactor that is housed in a casing, the reactor including: a coil that is formed by winding a winding wire; a ring-shaped magnetic core on which the coil is disposed; a casing that houses a combined body that includes the coil and the magnetic core; an insulator that is interposed between the coil and the magnetic coil; and a sealing resin that fills the casing. JP 2012-253384A discloses that an adhesive agent or an adhesive tape, for example, is used to integrate a plurality of core pieces that constitute the magnetic core into one piece, and integrate the core pieces and a gap member into one piece.

In recent years, as demand for hybrid vehicles and electric vehicles has increased, it is desired to improve productivity when manufacturing reactors. In terms of such a demand, the process of manufacturing a reactor that is housed in a casing has room for improvement.

In the process of manufacturing a reactor, when forming a reactor by attaching a plurality of core pieces to a coil, high accuracy is required when positioning the core pieces relative to each other and when positioning the magnetic core and the coil relative to each other. Therefore, according to JP 2012-253384A, the core pieces and the gap members are fixed to each other in advance, using an adhesive tape or the like, so that the magnetic core and the coil are accurately positioned relative to each other. It is expected that productivity can be improved when manufacturing a reactor by simplifying such a task of fixing the core pieces and the gap members to each other.

The present invention has been made in view of the above-described situation, and one objective of the present invention is to provide a reactor that makes it easier to hold constituent components thereof at predetermined positions relative to each other during the manufacturing process thereof, and that achieves excellent productivity.

### SUMMARY

A reactor according to one aspect of the present invention includes: a coil that includes winding portions; magnetic cores that are formed by combining a plurality of core pieces and gap members that are interposed between the core pieces, and include portions that are located inside the winding portions; interposed members that are interposed between inner surfaces of the winding portions and the magnetic cores, and include a core holding portion that secures gaps between the plurality of core pieces and position the core pieces; a casing that houses a combined body that includes the coil, the magnetic cores, and the interposed members; and a sealing resin portion that fills the casing and seals the combined body. The gap members are formed using a constituent resin of the sealing resin portion.

### Advantageous Effects

The above-described reactor makes it easier to hold constituent components thereof at predetermined positions relative to each other during the manufacturing process thereof, and achieves excellent productivity.

### BRIEF DESCRIPTION OF DRAWINGS

FIG. 1 is a schematic perspective view of a reactor according to a first embodiment.

FIG. 2 is a cross-sectional view along (II)-(II) of the reactor shown in FIG. 1.

FIG. 3 is a cross-sectional view along (III)-(III) of the reactor shown in FIG. 1.

FIG. 4 is a schematic exploded perspective view of the reactor according to the first embodiment.

FIG. 5 is a schematic exploded perspective view of a combined body that is provided in the reactor according to the first embodiment.

### DETAILED DESCRIPTION OF PREFERRED EMBODIMENTS

First, embodiments of the present invention will be listed and described.

(1) A reactor according to an embodiment of the present invention includes: a coil that includes winding portions; magnetic cores that are formed by combining a plurality of core pieces and gap members that are interposed between the core pieces, and include portions that are located inside the winding portions; interposed members that are interposed between inner surfaces of the winding portions and the magnetic cores, and include a core holding portion that secures gaps between the plurality of core pieces and position the core pieces; a casing that houses a combined body that includes the coil, the magnetic cores, and the interposed members; and a sealing resin portion that fills the casing and seals the combined body. The gap members are formed using a constituent resin of the sealing resin portion.

In the above-described reactor, gaps are secured between adjacent core pieces by the interposed members, and the core pieces can be accurately positioned relative to each other. The core pieces to which the interposed members are attached can be treated as an integrated element with gaps being provided between the core pieces, and therefore workability is excellent. By inserting, into the winding portions, the core pieces to which the interposed members are attached, it is possible to keep the core pieces in the state of having gaps therebetween inside the winding portions. Therefore, after the combined body is put in the casing, upon the casing being filled with an unsolidified constituent resin of the sealing resin portion, the unsolidified constituent resin flows into the gaps between the above-described core pieces, and gap members that match the gaps between the core pieces are formed. When the sealing resin portion is molded the combined body that includes the coil, the magnetic cores, and the interposed members can be sealed, and also the gap members can be formed between the core pieces. Therefore, during the process of manufacturing the reactor, it is possible to simplify the task of fixing the core pieces and the gap members to each other in advance using an adhesive or the like, and it is possible to achieve excellent productivity when manufacturing the reactor.

(2) In one example of the above-described reactor, the interposed members include a supporting portion that supports the core holding portion, and a flow path that is formed in the supporting portion and allows an unsolidified constituent resin of the sealing resin portion to flow into gaps between the plurality of core pieces when the sealing resin portion is molded.

With the above-described configuration, a flow path is formed in the supporting portion that is connected to the core holding portion that secures gaps between the plurality of core pieces, and therefore it is possible to reliably allow the above-described unsolidified constituent resin to flow along the flow path, into the gaps between the core pieces. Therefore, it is easier to form the gap members between the core pieces, using the constituent resin of the sealing resin portion.

(3) In one example of the above-described reactor, the sealing resin portion is molded using a soft resin.

In a reactor, when a current at a predetermined frequency is applied to the coil and the coil is excited, the magnetic cores repeat expansion and contraction and vibrate due to magnetostriction, and make noise. For example, the vibrations of the magnetic cores are transmitted to the casing and makes transmission noise. Since the sealing resin portion is formed using a soft resin, the vibrations from the magnetic cores are buffered by the sealing resin portion. Therefore, the vibrations of the magnetic cores are prevented from being transmitted to the casing, and it is possible to suppress the noise due to vibrations that are transmitted from the magnetic cores to the casing. In particular, in the above-described reactor, the gap members that are interposed between the core pieces are formed using the constituent resin of the sealing resin portion, and therefore, the vibrations from the magnetic cores (the core pieces) are more likely to be buffered, and it is possible to more effectively prevent the vibrations from the magnetic cores from being transmitted to the casing.

(4) In one example of the above-described reactor in which the sealing resin portion is formed using a soft resin, a gap is provided between: outer core pieces out of the magnetic core; and a mounting surface of the casing on which the outer core pieces are mounted, the outer core pieces being located outside the winding portions, and the sealing resin portion fills the gap.

Since the sealing resin portion that is formed using a soft resin is interposed between the outer core pieces and the mounting surface of the casing, the magnetic cores and the casing are prevented from being brought into direct contact with each other, and the vibrations from the magnetic cores can be buffered by the sealing resin portion. Therefore, the vibrations from the magnetic cores can be further prevented from being transmitted to the casing.

(5) In one example of the above-described reactor, the sealing resin portion is formed using a hard resin.

Since the sealing resin portion is formed using a hard resin, the magnetic cores are more firmly fixed to the sealing resin portion. Therefore, it is possible to suppress the vibrating of the magnetic cores per se. In particular, in the above-described reactor, the gap members that are interposed between the core pieces are formed using the constituent resin of the sealing resin portion, and therefore it is possible to more effectively suppress the vibrating of the magnetic cores (the core pieces) per se.

The following describes the details of embodiments of the present invention. Note that the present invention is not limited to these examples, and is specified by the scope of claims. All changes that come within the meaning and range of equivalency of the claims are intended to be embraced therein. Elements having the same name are denoted by the same reference signs throughout the drawings.

### First Embodiment

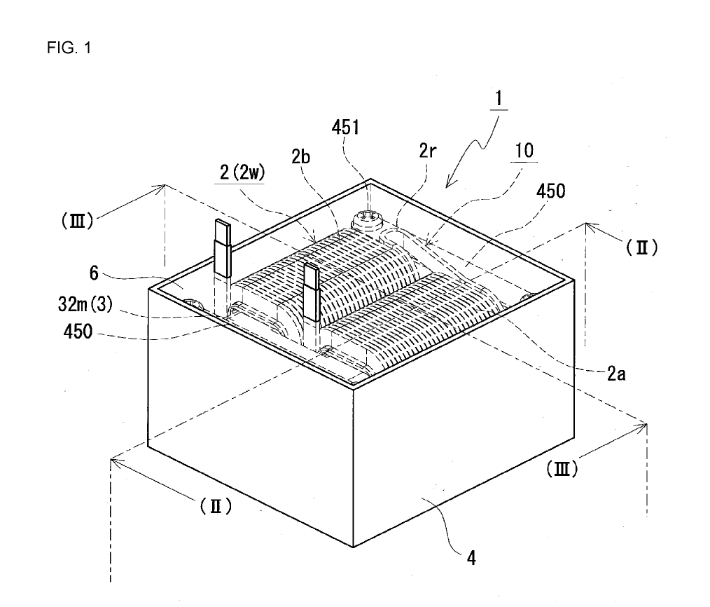

A reactor 1 according to a first embodiment will be described with reference to FIGS. 1 to 5.

### Reactor

### Overall Configuration

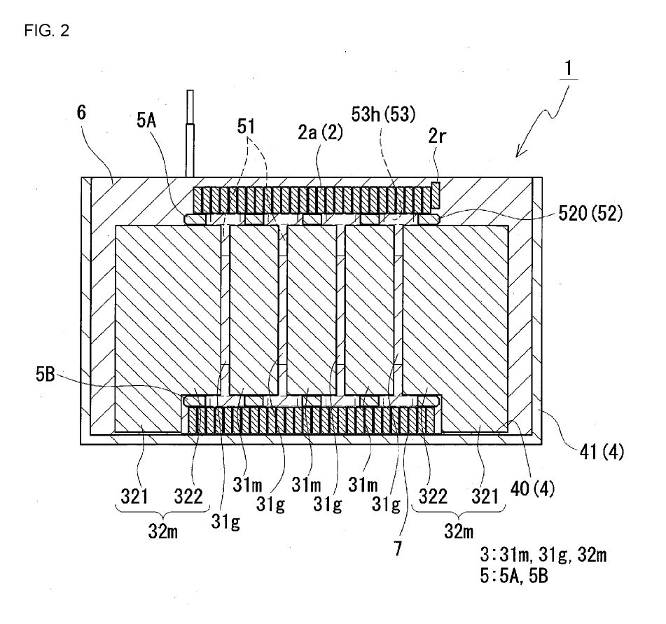

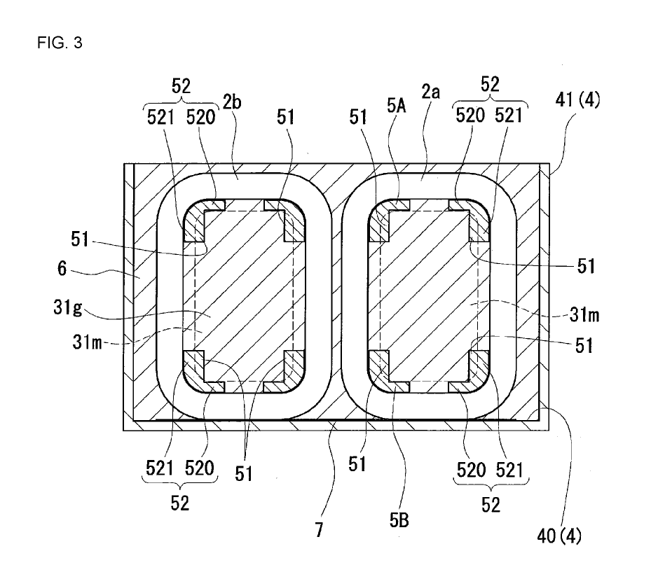

As shown in FIGS. 1 to 5, the reactor 1 according to the first embodiment includes: a coil 2 that has winding portions 2a and 2b that are formed by spirally winding a winding wire 2w; a magnetic core 3 that includes portions that are located inside the winding portions 2a and 2b; interposed members 5 that are interposed between the inner surfaces of the winding portions 2a and 2b and the magnetic cores 3; a casing 4 that houses a combined body 10 that includes the coil 2, the magnetic cores 3, and the interposed members 5; and a sealing resin portion 6 that fills the casing 4 to seal the combined body 10. The magnetic core 3 is formed by combining: a plurality of inner core pieces 31m that are entirely located inside the winding portions 2a and 2b; outer core pieces 32m that include portions that are located outside the winding portions 2a and 2b; and gap members 31g that are interposed between the inner core pieces 31m and between the inner core pieces 31m and the outer core pieces 32m. One feature of the reactor 1 according to the first embodiment is that the interposed members 5 include core holding portions 51 that secure gaps between the plurality of core pieces and that position the core pieces (see FIG. 3), and that the gap members 31g are formed using the constituent resin of the sealing resin portion 6 (see FIGS. 2 and 3). The following describes each component in detail. In the following description, it is assumed that the lower side is the installation side when the combined body 10 is installed in the casing 4 (the side on which a bottom plate portion 40 of the casing 4 is located), and that the upper side is the opposing side (the side on which the opening of the casing 4 is located).

### Coil

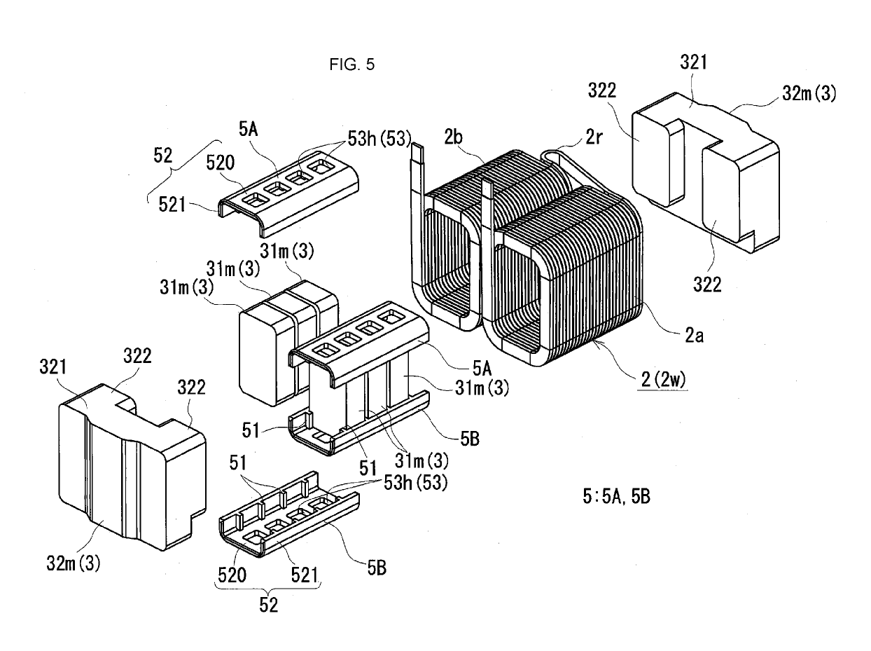

As shown in FIG. 5, the coil 2 includes: a pair of tubular winding portions 2a and 2b that are formed by spirally winding one continuous winding wire 2w; and a coupling portion 2r that couples the winding portions 2a and 2b to each other. The winding portions 2a and 2b have a hollow tube shape as a result of winding the winding wire 2w the same number of times in the same winding direction, and are arranged side by side (in the horizontal direction) such that their axial directions are parallel with each other. The coupling portion 2r is a portion that is bent in a U-like shape to connect the winding portions 2a and 2b. The coil 2 may be formed by spirally winding one winding wire that does not have a joint portion, or by manufacturing the winding portions 2a and 2b using separate winding wires and joining the end portions of the winding wires of the winding portions 2a and 2b to each other through welding or crimping. Both end portions of the coil 2 are drawn out of the winding portions 2a and 2b in appropriate directions, and are connected to a terminal member, which is not shown. An external device such as a power supply for supplying power to the coil 2 is connected via the terminal member.

The winding portions 2a and 2b in the present embodiment have a rectangular tube shape. The winding portions 2a and 2b that have a rectangular tube shape are winding portions whose end surfaces have a rectangular shape (including a square shape) and whose corners are rounded. Of course, the winding portions 2a and 2b may have a circular tube shape. The winding portions that have a circular tube shape are winding portions whose end surfaces have a closed surface shape (such as an oval shape, a perfect circle shape, or a race track shape).

The coil 2 that includes the winding portions 2a and 2b can be formed on the outer circumferential surface of a conductor such as a flat wire or a round wire that is made of a conductive material such as copper, aluminum, magnesium, or an alloy thereof, using a coated wire that includes an insulative coating that is made of an insulative material. In the present embodiment, the winding portions 2a and 2b are formed through edgewise-winding of a coated flat wire that includes a conductor that is made of a copper flat wire and an insulative coating that is made of enamel (typically polyamide imide).

### Magnetic Core

As shown in FIG. 5, the magnetic core 3 includes: a plurality of columnar inner core pieces 31m; a pair of outer core pieces 32m that have a U-like shape; and a plurality of gap members 31g that are interposed between the core pieces (see FIG. 2). The inner core pieces 31m are magnetic pieces that are entirely located inside the winding portions 2a and 2b, and the outer core pieces 32m are magnetic pieces that include portions that are located outside the winding portions 2a and 2b. The outer core pieces 32m may include portions that are located inside the winding portions 2a and 2b. In this example, the outer core pieces 32m include both portions that are located outside the winding portions 2a and 2b and portions that are located inside the winding portions 2a and 2b. The outer core pieces 32m are arranged such that their respective openings that have a U-like shape face each other, and the inner core pieces 31m are arranged between the outer core pieces 32m in the horizontal direction (side by side). In FIG. 5, gaps are provided between the inner core pieces 31m, and the gap members 31g (see FIG. 2) are formed between the inner core pieces 31m by filling the gaps with the constituent resin of the sealing resin portion 6, which will be described below. In this example, the gap members 31g are also provided in gaps between the inner core pieces 31m and the outer core pieces 32m that face the inner core pieces 31m, by filling the gaps with the constituent resin of the sealing resin portion 6. With this arrangement, the magnetic core 3 is attached so as to have a ring-like shape, and forms a closed magnetic circuit when the coil 2 is excited.

### Inner Core Pieces

It is preferable that the inner core pieces 31m have a shape that matches the shape of the winding portions 2a and 2b. In this example, as shown in FIG. 5, the inner core pieces 31m have a rectangular parallelepiped shape, and the corners of the inner core pieces 31m are rounded along the corners of the inner circumferential surfaces of the winding portions 2a and 2b. The number of inner core pieces 31m can be appropriately selected.

### Outer Core Pieces

The pair of outer core pieces 32m have the same shape, namely a substantially U-like shape when seen from above in FIG. 5. Each outer core piece 32m includes an outer core base portion 321 that has a rectangular parallelepiped shape and is located outside the winding portions 2a and 2b so as to span the winding portions 2a and 2b; and a pair of protruding portions 322 that protrude from the outer core base portion 321 and are located inside the winding portions 2a and 2b. The outer core base portion 321 and the pair of protruding portions 322 are molded integrally with each other. Also, in this example, a portion that protrudes in a direction that is opposite the direction in which the pair of protruding portions 322 protrude is molded integrally with the outer core base portion 321. The cross-sectional area of this protruding portion is substantially equal to the cross-sectional areas of the inner core pieces 31m and the protruding portions 322. The end surfaces of the pair of protruding portions 322 above have a shape and a size that are substantially the same as those of the end surfaces of the inner core pieces 31m, and the size and the length of protrusions of the pair of protruding portions 322 can be appropriately selected such that the end surfaces of the pair of protruding portions 322 have a predetermined magnetic circuit cross-sectional area that matches the coil 2. It is preferable that the pair of protruding portions 322 have a shape that matches the shape of the winding portions 2a and 2b. In this example, the corners of the pair of protruding portions 322 are substantially rounded along the corners of the inner circumferential surfaces of the winding portions 2a and 2b.

The lower surfaces of the outer core base portions 321 of the outer core pieces 32m that have a U-like shape protrude to positions that are downward of the lower surfaces of the inner core pieces 31m. Also, when the coil 2 and the magnetic core 3 are attached to each other, the lower surface of the coil 2 protrudes to a position that is downward of the lower surfaces of the outer core base portions 321, and a gap is formed between the lower surfaces of the outer core base portions 321 and the mounting surface of the bottom plate portion 40 of the casing 4, which will be described below (see FIG. 2). The height of the outer core base portions 321 is adjusted such that the above-described gap can be formed. The length of the gap between the lower surfaces of the outer core base portions 321 and the bottom plate portion 40 of the casing 4 is, for example, within the range from 0.3 mm to 3.0 mm inclusive. Here, a configuration in which the lower surface of the coil 2 protrudes to a position that is downward of the lower surfaces of the outer core base portions 321 is employed in order to form a gap between the lower surfaces of the outer core base portions 321 and the bottom plate portion 40 of the casing 4. However, the lower surface of the coil 2 and the lower surfaces of the outer core base portions 321 may be flush with each other. By interposing a joining layer 7, which will be described below, between the lower surface of the coil 2 and the bottom plate portion 40, a gap that corresponds to the thickness of the joining layer 7 is formed between the lower surfaces of the outer core base portions 321 and the bottom plate portion 40.

In this example, both the inner core pieces 31m and the outer core pieces 32m are powder compacts. A powder compact is typically obtained by molding a raw material powder that contains soft magnetic powder of a metal such as iron or an iron alloy (a Fe—Si alloy, a Fe—Ni alloy, etc.), and a binder (resin, etc.) and a lubricant if necessary, and then performing a heat treatment for the purpose of eliminating distortion that occurs during the molding process, for example. By using coated powder obtained by applying an insulating treatment to metal powder, or mixed powder obtained by mixing metal powder and an insulative material, as raw material powder, it is possible to obtain a powder compact that substantially includes metal particles and insulative materials that are interposed between the metal particles, after performing molding. This powder compact includes an insulative material, and therefore it can reduce eddy currents, resulting in lower energy loss.

### Gap Members

The gap members 31g are formed by filling the gaps between the core pieces with the constituent resin of the sealing resin portion 6, which will be described below. The gap members 31g will be described in detail later, in the description of the method for manufacturing a reactor.

### Interposed Members

The interposed members 5 are members that are interposed between: the inner surfaces of the winding portions 2a and 2b; and core portions of the magnetic core 3 that are located inside the winding portions 2a and 2b, and insulate the coil 2 and the magnetic core 3 from each other. This example is provided with a pair of interposed members 5, which are respectively provided for the winding portions 2a and 2b. The pair of interposed members 5 have the same shape, and therefore the following describes one of the interposed members 5 that is arranged for one of the winding portions 2a and 2b. In this example, the interposed member 5 includes a pair of divisional interposed members 5A and 5B that have division surfaces that extend in the axial direction of the winding portions. The following describes the components of the interposed member 5 in detail, mainly with reference to FIGS. 2, 3, and 5.

The pair of divisional interposed members 5A and 5B are members that each have a squared C shape, are not in contact with each other, and are arranged on portions of the inner core pieces 31m in the circumferential direction (see FIGS. 3 and 5). The divisional interposed members 5A and 5B have a length that spans the entire length of the plurality of inner core pieces 31m and the protruding portions 322 of the outer core pieces 32m in the axial direction when the core pieces 31m and 32m are attached so as to have a ring-like shape (see FIGS. 2 and 5). In this example, the pair of divisional interposed members 5A and 5B are arranged sandwiching the inner core pieces 31m from their upper and lower surfaces. That is, the divisional interposed member 5A (5B) includes: a top plate portion 520 that is arranged on the entire surface of the upper surface (the lower surface) of the inner core pieces 31m and the protruding portions 322 of the outer core pieces 32m; and a pair of leg portions 521 that are provided on the top plate portion 520 and are arranged to span the corners of the inner core pieces 31m and the protruding portions 322 of the outer core pieces 32m and portions of the side surfaces. The pair of divisional interposed members 5A and 5B include: core holding portions 51 that secure gaps between adjacent inner core pieces 31m when sandwiching the inner core pieces 31m, and position the inner core pieces 31m relative to each other; and flow paths 53 that allow an unsolidified constituent resin of the sealing resin portion 6, which will be described later, to flow into the gaps between the above-described inner core pieces 31m.

### Core Holding Portions

The plurality of core holding portions 51 that protrude inward are molded integrally with the inner surfaces of the top plate portion 520 and the leg portions 521. That is, the top plate portion 520 and the leg portions 521 serve as a supporting portion 52 that supports the core holding portions 51. Each core holding portion 51 is a protrusion that has an I-like shape and extends from a corner that is formed by the top plate portion 520 and a leg portion 521 along the leg portion 521. As shown in FIG. 3, the core holding portions 51 are inserted into the gaps between the inner core pieces 31m, at positions corresponding to the four corners of each inner core piece 31m. The areas surrounded by the dotted lines in FIG. 3 are the cross-sectional areas of the inner core pieces 31m.

The core holding portions 51 allow the inner core pieces 31m to be located at desired positions. The thickness of the core holding portions 51 (the thickness in the axial direction of the winding portions) corresponds to the thickness of the gap members 31g (see FIG. 2). Therefore, by arranging the pair of divisional interposed members 5A and 5B such that the core holding portions 51 are interposed between the inner core pieces 31m, it is possible to position the inner core pieces 31m, and it is possible to form gaps that match the thickness of the gap members 31g between the inner core pieces 31m. That is, by sandwiching the inner core pieces 31m between the pair of divisional interposed members 5A and 5B, it is possible to accurately position the portions of the magnetic core 3 that are located inside the winding portions.

The core holding portions 51 may be formed such that the cross-sectional area of the gap members 31g that are formed using the constituent resin of the sealing resin portion 6 is greater than or equal to 50% of the cross-sectional area of the inner core pieces 31m (see FIG. 3, the area surrounded by the dotted lines in FIG. 3 is the cross-sectional area of the inner core pieces 31m). It becomes easier to reliably secure the gaps between the inner core pieces 31m if the contact area between: the inner core pieces 31m or the protruding portions 322; and the core holding portions 51 is increased. However, if the area of the protrusions of the core holding portions 51 is increased in order to increase the contact area between: the inner core pieces 31m or the protruding portions 322; and the core holding portions 51, the cross-sectional area of the gaps between the core pieces decreases. As a result, the amount of the unsolidified constituent resin of the sealing resin portion 6 that fills the gaps between the core pieces decreases, and the cross-sectional area of the gap members 31g that are formed using the constituent resin of the sealing resin portion 6 decreases. If the amount of the unsolidified constituent resin of the sealing resin portion 6 that fills the gaps between the core pieces decreases, the area where the core pieces are fixed to each other by the sealing resin portion 6 decreases. Therefore, the core pieces cannot be firmly fixed to each other, which leads to the risk of the core pieces vibrating during the operation of the reactor 1. Therefore, it is preferable that the length of the projections of the core holding portions 51 is adjusted such that the gaps between the core pieces can be secured and the cross-sectional area of the gap members 31g that are formed by the constituent resin of the sealing resin portion 6 is greater than or equal to 50% of the cross-sectional area of the inner core pieces 31m. The cross-sectional area of the gap members 31g that are formed by the constituent resin of the sealing resin portion 6 may be greater than or equal to 60%, or greater than or equal to 70%, or even greater than or equal to 80% of the cross-sectional area of the inner core pieces 31m.

### Flow Paths

The flow paths 53 are formed in the top plate portion 520. When the sealing resin portion 6, which will be described later, fills the casing 4, the flow paths 53 allow the unsolidified constituent resin of the sealing resin portion 6 to flow into the gaps between the inner core pieces 31m. In this example, a plurality of through holes 53h are formed in the top plate portion 520 as the flow paths 53 such that the gaps between the inner core pieces 31m are exposed to the outside. The unsolidified constituent resin usually fills the casing 4 from the lower side of the casing 4 in order to prevent the unsolidified constituent resin from including bubbles. Therefore, it is particularly preferable that the through holes 53h are formed in the divisional interposed member 5B that is located on the side of the lower surfaces of the inner core pieces 31m. Due to the through holes 53h being provided, it is possible to remove air via the through holes 53h when filling the above-described unsolidified constituent resin.

In addition, groove portions (not shown) may be formed in the inner circumferential surfaces and the outer circumferential surfaces of the top plate portion 520 and the leg portions 521 as the flow paths 53. For example, lateral groove portions that extend inward from end portions of the divisional interposed members 5A and 5B in the axial direction of the winding portions and join the through holes 53h may be formed. When a plurality of through holes 53h are provided, lateral groove portions that connect the through holes 53h to each other may be formed. This configuration allows the unsolidified constituent resin of the sealing resin portion 6 to easily flow into the gaps between the inner core pieces 31m.

As the constituent material of the interposed members 5, a polyphenylene sulfide (PPS) resin, a polytetrafluoroethylene (PTFE) resin, a liquid crystal polymer (LCP), a polyamide (PA) resin such as nylon 6 or nylon 66, and a thermoplastic resin such as a polybutylene terephthalate (PBT) resin or an acrylonitrile butadiene styrene (ABS) resin may be used, for example. In addition, it is also possible to use a thermosetting resin such as an unsaturated polyester resin, an epoxy resin, a urethane resin, or a silicone resin. The interposed members 5 can be easily manufactured using a known molding method such as injection molding using the above-described resins.

In this example, the interposed members 5 are arranged such that the pair of divisional interposed members 5A and 5B are independent of each other. However, a fixing member that fixes the positions of the pair of divisional interposed members 5A and 5B may be provided. For example, the divisional interposed members 5A and 5B may be fixed to the core pieces using an adhesive tape. By using an adhesive tape to fix the divisional interposed members 5A and 5B, it is possible to prevent the interposed members 5 from having a complex shape, and prevent the amount of the constituent material from increasing. Also, workability is excellent because the interposed members 5 can be fixed by performing the task of attaching the adhesive tape, which is easy. Alternatively, it is possible to provide the pair of divisional interposed members 5A and 5B with fitting portions that fit to each other, or band the divisional interposed members 5A and 5B together using a rubber band or a clamping band.

Also, although the interposed members 5 are arranged on portions of the inner core pieces 31m in the circumferential direction in this example, the interposed members 5 may be arranged along the entire circumferences of the inner core pieces 31m. The interposed members 5 only need to secure the gaps between the inner core pieces 31m. It is possible to reduce the amount of the constituent material of the interposed members 5 by employing a configuration in which the interposed members 5 are arranged on portions of the inner core pieces 31m in the circumferential direction.

Furthermore, although the pair of divisional interposed members 5A and 5B included in the interposed members 5 in this example have the same shape, they may have different shapes. For example, it is possible to allow the unsolidified constituent resin of the sealing resin portion 6 that fills the casing 4 to more efficiently flow into the gaps between the inner core pieces 31m by increasing the number of through holes 53h that are formed in the divisional interposed member 5B that is located on the lower surface side of the inner core pieces 31m.

### Casing

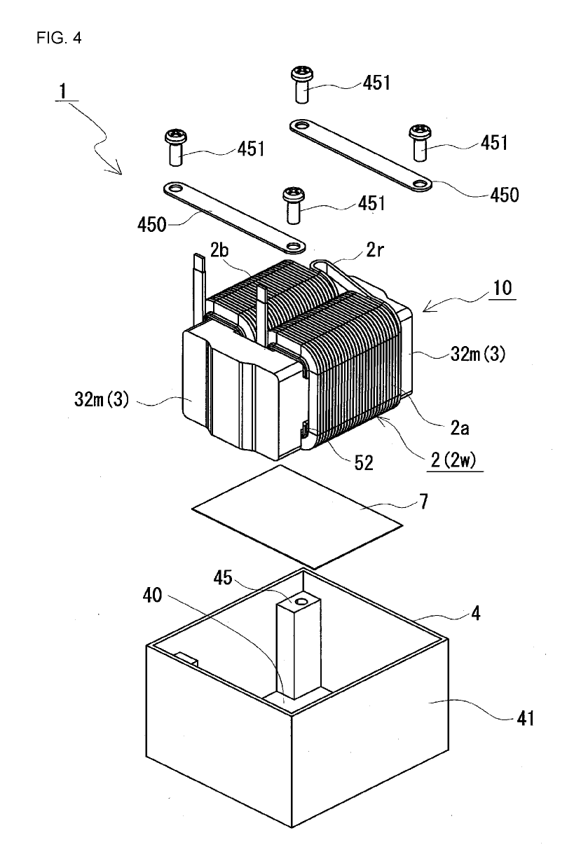

As shown in FIG. 4, the casing 4 includes: the bottom plate portion 40 that is flat and on which the combined body 10 is mounted; and a side wall portion 41 that has a substantially rectangular frame shape and stands on the bottom plate portion 40 and surrounds the combined body 10. The casing 4 has a substantially rectangular box shape with an opening that is on the opposite side (upper side) to the bottom plate portion 40. In the reactor 1, the combined body 10 is housed in the casing 4. Thus, it is possible to protect the combined body 10 from the external environment (dust, corrosion, etc.), and to provide mechanical protection. In this example, the lower surface of the bottom plate portion 40 of the casing 4 is fixed so as to be in contact with the upper surface of an installation target such as a cooling base (not shown), and the reactor 1 is installed on the installation target. Although FIG. 1 shows an installation state in which the bottom plate portion 40 is on the lower side, it is possible that the bottom plate portion 40 is on the upper side or a lateral side.

The casing 4 shown in this example is a metal casing into which the bottom plate portion 40 and the side wall portion 41 are integrated. In general, metal has a relatively high thermal conductivity. Therefore, if a metal casing is used, the casing can be entirely used as a heat dissipation path, and heat that is generated by the combined body 10 can be efficiently dissipated to an external installation target (e.g. a cooling base). Thus, the heat dissipation properties of the reactor 1 can be improved. Examples of the constituent material of the casing 4 include, aluminum and an alloy thereof, a magnesium and an alloy thereof, a copper and an alloy thereof, silver and an alloy thereof, iron, and austenitic stainless steel. The casing 4 can be lightweight if it is formed using aluminum, magnesium, or an alloy of aluminum and magnesium.

The casing 4 shown in this example is provided with a stay attachment portion 45 at the four corners of the casing 4. Stays 450 are arranged over the upper surface of the outer core base portions 321 of the outer core pieces 32m, and the stays 450 are fixed to the stay attachment portion 45 using screws 451. Thus, the combined body 10 can be fixed to the casing 4, with the combined body 10 being pressed to the bottom plate portion 40.

### Joining Layer

As shown in FIGS. 2 to 4, the reactor 1 shown in this example is provided with the joining layer 7 on the installation surface of the combined body 10. The joining layer 7 is interposed between the lower surface of the coil 2 of the combined body 10 and the bottom plate portion 40. Due to the joining layer 7 being provided, the combined body 10 can be firmly fixed to the bottom plate portion 40. Thus, it is possible to restrict the coil 2 from moving, improve the heat dissipation properties, and stably fix the reactor 1 to the installation target. Preferably, the constituent material of the joining layer 7 is a material that includes an insulative resin, in particular, a ceramic filler or the like, and has excellent heat dissipation properties (e.g. a thermal conductivity of 0.1 W/m·K or more, even more preferably 1 W/m·K or more, and particularly preferably 2 W/m·K or more). Specific examples of the resin include thermosetting resins such as an epoxy resin, a silicone resin, and unsaturated polyester, and thermoplastic resins such as a PPS resin and LCP. The joining layer 7 may have a sheet-like shape, or be formed through coating or spraying.

### Sealing Resin Portion

As shown in FIG. 1, the sealing resin portion 6 is a member that fills the casing 4, and seals the combined body 10 that is housed in the casing 4. The sealing resin portion 6 fills the casing 4 such that the upper surface of the combined body 10, excluding both end portions of the coil 2, is embedded in the sealing resin portion 6 (see FIG. 2). In the reactor 1, the combined body 10 is sealed using the sealing resin portion 6, and the combined body 10 is thereby fixed to the casing 4. Thus, it is possible to electrically and mechanically protect the combined body 10, protect the combined body 10 from the external environment, prevent the magnetic core 3 from vibrating when electricity is applied to the coil 2, and reduce noise that is caused by the vibrations.

As shown in FIG. 2, the constituent resin of the sealing resin portion 6 fills the gaps between the core pieces 31m formed by the above-described core holding portions 51. The gap members 31g that are interposed between the core pieces are formed by the constituent resin of the sealing resin portion 6.

As the constituent resin of the sealing resin portion 6, an epoxy resin, a urethane resin, a silicone resin, an unsaturated polyester resin, or a PPS resin may be used, for example. In particular, an epoxy resin and a urethane resin are preferable because they are soft and inexpensive. From the view point of improving the heat dissipation properties, ceramic filler with a high thermal conductivity, such as alumina or silica, may be mixed into the sealing resin portion 6.

A soft resin may be used as the constituent resin of the sealing resin portion 6. If a soft resin is used, it is preferable that the Young's modulus (20° C. to 100° C.), which is a kind of modulus of elasticity, is smaller than or equal to 100 MPa. If the sealing resin portion 6 is formed using a soft resin, the vibrations from the magnetic core 3 are buffered by the sealing resin portion 6. Therefore, it is possible to suppress the noise caused by vibrations that are transmitted from the magnetic core 3 to the casing 4, and therefore it is possible to more easily reduce noise that is caused by the vibrations from the magnetic core 3. In particular, by forming the gap members 31g between the core pieces 31m using the constituent resin of the sealing resin portion 6, it is possible to more easily buffer the vibrations from the core pieces 31m, and to further suppress the noise caused by vibrations that are transmitted from the magnetic core 3 (the core pieces 31m) to the casing 4. The Young's modulus (20° C. to 100° C.) of this soft resin is even more preferably smaller than or equal to 20 MPa, and particularly preferably smaller than or equal to 5 MPa. If the Young's modulus of the soft resin is too small, the magnetic core 3 is likely to vibrate. Therefore, the Young's modulus is preferably greater than or equal to 1 kPa, and particularly preferably greater than or equal to 100 kPa. Here, note that the Young's modulus of the constituent resin of the sealing resin portion 6 is a value that is obtained based on JIS K7161-2, for example.

Alternatively, a hard resin may be used as the constituent resin of the sealing resin portion 6. If a hard resin is used, it is preferable that the Young's modulus (20° C. to 100° C.), which is a kind of modulus of elasticity, is greater than or equal to 1 GPa. If the sealing resin portion 6 is formed using a hard resin, the magnetic core 3 is more firmly fixed to the sealing resin portion 6. Therefore, it is possible to suppress the vibrating of the magnetic core 3 per se. In particular, by forming the gap members 31g between the core pieces 31m using the constituent resin of the sealing resin portion 6, it is possible to suppress the vibration of the core pieces 31m per se. The Young's modulus (20° C. to 100° C.) of this hard resin is even more preferably greater than or equal to 5 GPa, and particularly preferably greater than or equal to 10 GPa.

### Method for Manufacturing Reactor

The reactor 1 that has the above-described configuration can be manufactured by, for example: assembling the coil 2, the plurality of core pieces 31m and 32m, and the interposed members 5 to form the combined body 10; putting the combined body 10 into the casing 4; and filling the casing 4 with the unsolidified constituent resin of the sealing resin portion 6 and solidifying the constituent resin.

### Manufacturing of Combined Body

First, as shown in FIG. 5, the plurality of inner core pieces 31m are sandwiched between the pair of divisional interposed members 5A and 5B. At this time, the core holding portions 51 that are formed on the divisional interposed members 5A and 5B are interposed between the inner core pieces 31m. As a result, the inner core pieces 31m are positioned, and gaps that match the thickness of the gap members 31g are formed between the inner core pieces 31m. Assemblies that each include the inner core pieces 31m sandwiched between the pair of divisional interposed members 5A and 5B are respectively inserted into the winding portions 2a and 2b of the coil 2. Then, the pair of outer core pieces 32m are attached to the ends of this assembly, and thus the combined body 10 is formed. The protruding portions 322 of the outer core pieces 32m are inserted into spaces that are formed at the end portions of the pairs of divisional interposed members 5A and 5B. As a result, the end surfaces of the protruding portions 322 abut against and are stopped by the core holding portions 51 at the end portions of the divisional interposed members 5A and 5B. Thus, the protruding portions 322 are positioned and arranged inside the winding portions 2a and 2b. The combined body 10 can be treated as an integrated element in which the core pieces 31m and 32m are positioned by the interposed members 5.

In this example, the inner core pieces 31m that are sandwiched between the pairs of divisional interposed members 5A and 5B are treated as an assembly, and this assembly is sandwiched between the pair of outer core pieces 32m. Alternatively, it is possible to form a U-shaped assembly in which the inner core pieces 31m and the protruding portions 322 of one of the outer core pieces 32m are sandwiched by the pairs of divisional interposed members 5A and 5B, insert the U-shaped assembly into the winding portions 2a and 2b of the coil 2 from the openings side of the U-shape, and attach the other outer core piece 32m.

Putting Combined Body into Casing

Next, the combined body 10 is put into the casing 4 (see FIG. 4). In this example, first, the joining layer 7 is positioned on the lower surface of the combined body 10, and then the combined body 10 is put into the casing 4. Also, the stays 450 are positioned on the upper surfaces of the outer core base portions 321 of the outer core pieces 32m, the stays 450 are fixed to the stay attachment portion 45 of the casing 4 using the screws 451, and thus the combined body 10 is fixed inside the casing 4.

### Filling and Solidifying Constituent Resin of Sealing Resin Portion

The casing 4 that houses the combined body 10 is filled with an unsolidified constituent resin of the sealing resin portion 6. The above-described unsolidified constituent resin that fills the casing 4 covers the outer circumferential surface of the coil 2 and the outer circumferential surface of the magnetic core 3, and also spreads through the gap between the coil 2 and the magnetic core 3. Then, the above-described unsolidified constituent resin flows along the flow paths 53 that are provided in the interposed members 5, and flows into and fills the gaps between the above-described core pieces 31m and 32m. By solidifying the above-described constituent resin in this state, the combined body 10 is sealed and the gap members 31g are formed between the core pieces 31m and 32m.

### Primary Effects

In the above-described reactor 1, when the sealing resin portion 6 is molded, the combined body 10 that includes the coil 2, the magnetic core 3, and the interposed members 5 can be sealed, and also the gap members 31g can be formed between the core pieces 31m. Therefore, it is possible to simplify the conventional task of fixing the core pieces and the gap members to each other in advance using an adhesive or the like, and it is possible to achieve excellent productivity when manufacturing the reactor 1.

### Other Configurations

The above-described reactor 1 may be provided with sensors (not shown) that measure physical amounts regarding the reactor 1, such as a temperature sensor, a current sensor, a voltage sensor, and a magnetic flux sensor. Sensors may be located in a space that is formed between the winding portions 2a and 2b, for example.

### INDUSTRIAL APPLICABILITY

The reactor according to the present invention can be used in a preferable manner in various converters such as an on-board converter (typically a DC-DC converter) that is mounted on a vehicle such as a hybrid vehicle, a plug-in hybrid vehicle, an electric vehicle, or a fuel cell vehicle, and a converter for an air conditioner, and in constituent components of a power conversion device.

1. A reactor comprising:
a coil that includes a pair of winding portions that are arranged side by side;
magnetic cores that are formed by combining a plurality of core pieces and gap members that are interposed between the core pieces, and include portions that are located inside the winding portions;
interposed members that are interposed between inner surfaces of the winding portions and the magnetic cores, and include a core holding portion that secures gaps between the plurality of core pieces, and position the core pieces;
a casing that houses a combined body that includes the coil, the magnetic cores, and the interposed members; and
a sealing resin portion that fills the casing and seals the combined body;
wherein the magnetic cores include:
inner core pieces that are entirely located inside the winding portions; and
outer core pieces that each have a U-like shape and each include an outer core base portion that is located outside the winding portions so as to span the winding portions, and a pair of protruding portions that protrude from the outer core base portion and are located inside the winding portions, the outer core base portion and the protruding portions being integrated into one piece,
the interposed members each include a pair of divided interposed members that have division surfaces that extend in an axial direction of the winding portions, and sandwich the plurality of core pieces, and
the gap members are formed using a constituent resin of the sealing resin portion.

2. The reactor according to claim 1,
wherein the interposed members include a supporting portion that supports the core holding portion, and a flow path that is formed in the supporting portion and allows an unsolidified constituent resin of the sealing resin portion to flow into gaps between the plurality of core pieces when the sealing resin portion is molded.

3. The reactor according to claim 1,
wherein the sealing resin portion is formed using a soft resin.

4. The reactor according to claim 3,
wherein a gap is provided between: outer core pieces out of the magnetic cores; and a mounting surface of the casing on which the outer core pieces are mounted, the outer core pieces being located outside the winding portions, and
the sealing resin portion fills the gap.

5. The reactor according to claim 1,
wherein the sealing resin portion is formed using a hard resin.

6. The reactor according to claim 1, wherein the sealing resin portion is formed using a soft resin.

7. The reactor according to claim 1, wherein the sealing resin portion is formed using a hard resin
